(19) United States
(12) Patent Application Publication
(10) Pub. No.: US 2025/0348357 A1
(43) Pub. Date: Nov. 13, 2025

(54) Heterogeneous Accelerators Connected via a Time Sensitive Networking Bus

(71) Applicant: Micron Technology, Inc., Boise, ID (US)

(72) Inventors: Saideep Tiku, Folsom, CA (US); Poorna Kale, Folsom, CA (US)

(21) Appl. No.: 18/593,802

(22) Filed: Mar. 1, 2024

Related U.S. Application Data
(60) Provisional application No. 63/493,512, filed on Mar. 31, 2023.

(51) Int. Cl. G06F 9/50; G06F 9/48

(52) U.S. Cl. CPC G06F 9/5016; G06F 9/4837

(57) ABSTRACT

An apparatus having: a time sensitive networking bus; a plurality of accelerators connected to the time sensitive networking bus to accelerate multiplication and accumulation operations; and a plurality of components connected to the time sensitive networking bus. The components are configured to: run a plurality of applications; generate, in the applications, tasks of multiplication and accumulation operations; assign the tasks to the accelerators; and allocate virtual channels over the time sensitive networking bus from the applications to the accelerators based on timing data of the applications.

### RELATED APPLICATIONS

The present application claims priority to Prov. U.S. Pat. App. Ser. No. 63/493,512 filed Mar. 31, 2023, the entire disclosures of which application are hereby incorporated herein by reference.

### TECHNICAL FIELD

At least some embodiments disclosed herein relate to computer communications in general and more particularly, but not limited to, virtual channel allocation for communications over time sensitive networking bus to access heterogeneous accelerators for multiplication and accumulation operations.

### BACKGROUND

Some applications, such as the streaming of audio and video content for playing back over a computer network, are sensitive to delay and its variations in data delivery over the computer network. When a data consuming application (e.g., a media player) fails to receive a piece of data from a data transmission application (e.g., a content streamer) in time for the use of the piece of data, synchronization between the applications is broken, causing a glitch in the data consuming application. Buffering is typically used to reduce the likelihood of a piece of data failing to arrive timely.

Time sensitive networking includes techniques for time synchronization among devices involved in communications over a network, techniques for scheduling and traffic shaping, and techniques for selection of communication paths, path reservations and fault-tolerance.

Many techniques have been developed to accelerate the computations of multiplication and accumulation. For example, multiple sets of logic circuits can be configured in arrays to perform multiplications and accumulations in parallel to accelerate multiplication and accumulation operations. For example, photonic accelerators have been developed to use phenomenon in optical domain to obtain computing results corresponding to multiplication and accumulation. For example, a memory sub-system can use a memristor crossbar or array to accelerate multiplication and accumulation operations in electrical domain.

A computing system can be configured to include a number of components connected via a number of connections to memory sub-systems. For example, connections according to compute express link (CXL) can be used to provide high-speed connections among a central processing unit (CPU), memory, a graphics processing unit (GPU), etc.

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 shows a computing system configured to dynamically allocate virtual channels for communication over a time sensitive networking bus to access accelerators of multiplication and accumulation operations according to one embodiment.

FIG. 2 shows a heterogeneous accelerator sub-system according to one embodiment.

FIG. 3, FIG. 4, and FIG. 5 illustrate examples of dynamic allocations of virtual channels for communication over a time sensitive networking bus to access accelerators of multiplication and accumulation operations according to one embodiment.

FIG. 6 shows an analog accelerator implemented using microring resonators according to one embodiment.

FIG. 7 shows another accelerator implemented using microring resonators according to one embodiment.

FIG. 8 shows the computation of a column of weight bits multiplied by a column of input bits to provide an accumulation result according to one embodiment.

FIG. 9 shows the computation of a column of multi-bit weights multiplied by a column of input bits to provide an accumulation result according to one embodiment.

FIG. 10 shows the computation of a column of multi-bit weights multiplied by a column of multi-bit inputs to provide an accumulation result according to one embodiment.

FIG. 11 shows a processing unit configured to perform matrix-matrix operations according to one embodiment.

FIG. 12 shows a processing unit configured to perform matrix-vector operations according to one embodiment.

FIG. 13 shows a processing unit configured to perform vector-vector operations according to one embodiment.

FIG. 14 shows a method of accessing accelerators of multiplication and accumulation operations over a time sensitive networking bus according to one embodiment.

### DETAILED DESCRIPTION

At least some embodiments disclosed herein provide techniques to manage access to, over a time sensitive networking bus, accelerators of multiplication and accumulation operations.

For example, a manager can be configured on the time sensitive networking bus to dynamically allocate virtual channels over the time sensitive networking bus to satisfy the timing requirements of computing tasks that use the accelerators connected to the time sensitive networking bus.

For example, the accelerators connected to the time sensitive networking bus can be implemented using different techniques, such as memristor crossbars, synapse memory cell arrays, microring resonators, logical multiply-accumulate units, in-memory processors, etc. The accelerators of different types can have different computing latency, energy consumption, etc. The manager can be configured to manage the time sensitive networking bus to satisfy timing requirements of computing tasks that use the accelerators and optionally, optimize the energy performance of the accelerator sub-system.

For example, a plurality of hosts or computing components/agents can share a set of heterogeneous accelerators of multiplication and accumulation operations over a time sensitive networking bus. A network manager can be configured to dynamically adjust the allocation of virtual channels through the time sensitive networking bus from the hosts (or computing components or agents) to the accelerators to meet the timing requirements of the applications running in the hosts (or computing components or agents). The accelerators can have different latency characteristics and energy consumption characteristics. An accelerator manager can be configured to assign acceleration tasks to accelerators via balancing accelerator workloads, optimizing timing performance over the time sensitive networking bus, and optimizing the energy performance of the overall system in performing the computations accelerated via the accelerators. The accelerator manager and the network manager can be combined and configured in a same computing component, agent or application connected to the time sensitive networking bus.

For example, a computing system can have a plurality of components operable as agents to perform computing tasks, such as inferences based on artificial neural network models. The computing agents can outsource operations of multiplications and accumulations to the accelerators connected on the time sensitive networking bus and obtain the results of multiplication and accumulation from the accelerators over the time sensitive networking bus.

The time sensitive networking bus can include a set of physical connections from the components/computing agents to accelerators and other devices, such as memory devices. For example, the connections can be in accordance with computer express link (CXL), peripheral component interconnect express (PCIe), ethernet, or other communications standards. The physical connections can be arranged to have a topology of a network with redundant paths, or alternative paths, or both. Communication congestion over certain physical connections in the bus during certain time periods can impact the delay in communications over possible routes/paths in the bus. Further, different accelerators can have different delays in producing computing results. Excessive computing tasks assigned to the accelerators can also cause delays.

A manager can be configured on the time sensitive networking bus to dynamically allocate or configure virtual channels for communications among the components and the accelerators over the time sensitive networking bus.

A virtual channel can specify a set of rules for communications over the time sensitive networking bus for a component or agent to access an acceleration service for multiplication and accumulation operations. Devices and physical connections involved in the implementation of the virtual channel are required to perform communication operations according to the rules such that the timing and delay over the virtual channel can be deterministic and guaranteed to satisfy the timing requirements of the component agent.

Optionally, an acceleration service can be virtualized for being performed by one or more of the accelerators connected to the time sensitive networking bus.

Optionally, or in combination, a computing agent can also be virtualized and hosted on one or more of the components.

In general, there can be a large number of solution candidates in resource allocation and rule formulation to set up and optimize virtual channels for improved performance of the computing system as a whole, including in the speed in computation and in the amount of energy expenditure.

Components on a time sensitive networking bus can be configured to communicate with each other, or cooperate with each other, or both (e.g., through the services of a memory connected on the timing sensitive networking bus). The components or computing agents can be configured to identify timing data indicative of the urgency levels, timing requirements, etc., of computing tasks (e.g., to be performed via running applications or executing routines) in accessing the memory and in accessing the accelerators for multiplication and accumulation operations.

For example, the timing data can be communicated to the manager connected to the time sensitive networking bus; and the manager can schedule and shape communication traffic over the time sensitive networking bus via the dynamic allocation of virtual channels to compensate for network delays and congestion in meeting the timing requirements in a deterministic way and in improving or optimizing system performance in view of urgency levels of the computing tasks.

The workloads and deadlines of computing tasks in accessing services (e.g., memory/storage services, acceleration services) over the time sensitive networking bus can change. The manager can dynamically adjust virtual channel allocations in the bus to guarantee that communications over the virtual channels satisfy the timing requirements based on which the virtual channels are allocated.

When there are insufficient resources to allocate a virtual channel to meet the timing requirement of a computing task, the allocation of the virtual channel is delayed. Optionally, when an urgent task requires resources for a virtual channel, the usage of an existing virtual channel allocated to a task having a lower urgency level can be paused to free up resources for the urgent task, or reallocated to use a different set of resources, or reconfigured to satisfy modified timing requirements.

In some instances, resources can be reallocated among allocated virtual channels to free up resources to allow an additional virtual channel to be allocated and meet the timing requirements of a new computing task.

When resources become available (e.g., upon completion of a computing task, reallocation or modification of an existing virtual channel, pausing of an existing virtual channel), the allocation of the virtual channel that has been delayed can be performed.

Optionally, each computing agent maintains an urgency level for its workload or computing task associated with running an application or routine in accessing memory/storage resources. The manager orchestrates the virtual channel allocation and the accelerator allocation based on the requirements of various computing agents and the urgency levels to prioritize resource allocations to improve or maximize the overall performance of the system.

The computations of a virtual channel allocation for an acceleration task can include the selection of an accelerator from available accelerators on the bus and the determination of the communication rules for one or more physical connections in the bus to provide the virtual channel to the selected accelerator. The validity or selection of the communication rules can be limited by the workloads of the communication resources or devices involved in the physical connections and the capabilities of the devices and connections in handling communications. A set of valid rules can implement low, deterministic delays that satisfy the timing requirements of the acceleration tasks.

Optionally, the manager can be configured to perform inference computations in the selection of an accelerator and in the determination, selection, search, optimization of the communication rules for the allocation and adjustment of a virtual channel to the accelerator. Optionally, the manager can optimize the performance of the system as a whole through the prediction of the workloads of the time sensitive networking bus, such as the timing of computing tasks to be performed, the urgency levels of the computing tasks, the bandwidth usages of the computing tasks, the durations of the computing tasks, the access latency requirements of the computing tasks, etc.

For example, when the computing system is used to perform routine or similar tasks over a period of time, there can be patterns in the computing tasks; and an artificial neural network can be trained, via the activity and timing data collected during the period of time to predict computing tasks that will use the time sensitive networking bus in a subsequent period of time, and predict the attributes of the computing tasks (e.g., urgency levels, latency requirements, bandwidth usages). By performing virtual channel allocation in view of the predicted computing tasks, the manager can optimize the overall performance of the system (e.g., by avoid allocation of virtual channels to tasks of low urgency levels that may block the allocation of virtual channels to tasks of high urgency levels).

Optionally, the manager can adjust the assignment of an acceleration task to an accelerator. For example, an acceleration task initially assigned to an accelerator can be provided with access to use an alternative accelerator to free up the initially provisioned connection resources for another task.

Optionally, or in combination, the manager can adjust the hosting of applications on computing components. For example, an application or routine initially running on a component can be moved to an alternative component to free up connection resources to facilitate the implementation of another virtual channel.

In general, adjustments of assignments of acceleration tasks to accelerators and the hosting of applications/routines in components can change resource availability across the time sensitive networking bus and free up resources (e.g., available connectivity and bandwidth of physical connections, memory/storage services) for the allocation of a new virtual channel for an urgent computing task for improved overall performance of the system.

The manager can be configured to perform inference computations in moving applications/routines among computing agents/components available in the system, adjusting assignments of acceleration tasks of the applications/routines to accelerators, reserving resources for predicted computing tasks of high urgency levels, etc. The inference computations can be performed during virtual channel allocation or adjustment, in view of known or predicted (or both types of) resource restrictions (e.g., communication congestion, bandwidth and latencies of physical connections).

Optionally, the inference computations can be accelerated using the accelerators connected on the bus. Alternatively, the manager can be configured to include an inference logic circuit to accelerate the inference computations in the virtual channel allocation. For example, the inference logic circuit can include multiplier-accumulator units that are configured to perform at least part of multiplication and accumulation operations in an analog form.

For example, the manager can include a synapse memory accelerator having an array of memory cells programmable in a synapse mode to support multiplication and accumulation operations in an analog form. Alternatively, a memristor crossbar array can be used to accelerate multiplication and accumulation operations in an analog form. Alternatively, multiple sets of logic circuits can be configured in a form of arrays to perform multiplications and accumulations in parallel to accelerate multiplication and accumulation operations.

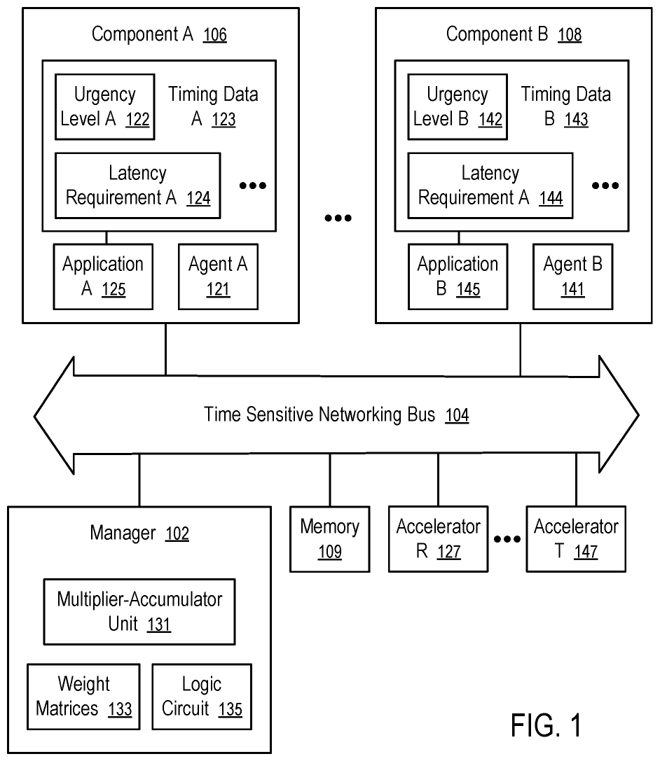

FIG. 1 shows a computing system configured to dynamically allocate virtual channels for communication over a time sensitive networking bus 104 to access accelerators of multiplication and accumulation operations according to one embodiment.

In the computing system of FIG. 1, the time sensitive networking bus 104 has multiple physical connections among components 106, . . . , 108, a memory 109, and accelerators 127, . . . , 147. The physical connections can have a topology of a network with redundant paths, or alternative paths, or both, to reach computing resources of the components 106, . . . , 108, acceleration resources of the accelerators 127, . . . , 147, memory/storage resources of the memory 109, etc. Optionally, the memory 109 includes multiple memory devices and/or memory sub-systems having multiple connections to the bus 104 to provide memory services, caching services, buffering services, data storage services, etc.

Each physical connection can connect one or more of the devices (e.g., one or more of components 106, . . . , 108, memory 109, and accelerators 127, . . . , 147). Such a connection can be in accordance with computer express link (CXL), peripheral component interconnect express (PCIe), ethernet, or other communications standards.

The physical connections form a network with multiple alternative ways to service a component (e.g., 106 or 108) in running an application (e.g., 125 or 145) (e.g., a computing task, a routine of operations). Optionally, the time sensitive networking bus 104 can include switches, hubs, etc., for improved flexibility in configuring virtual channels. In some instances, a computing task can be implemented in multiple ways (e.g., via an application 125 running in a component 125, or the same application 125 or another application 145 running in another component 145).

Each component (e.g., 106 or 108) in the system can have an agent (e.g., 121 or 141) that identifies timing data (e.g., 123 or 143) of the computing tasks (e.g., application 125 or 145) running in the component (e.g., 106 or 108) to support the scheduling and shaping of traffic in the time sensitive networking bus 104.

For example, the timing data 123 of the application 125 running in the component 106 can specify the urgency level 122 of the application 125 in accessing an accelerator (e.g., 127 or 147) or the memory 109 over the time sensitive networking bus 104. Resources of the time sensitive networking bus 104 can be allocated or provisioned, e.g., in the form of virtual channels, according to priorities indicated by the urgency level 122. Further, the time data 123 can include the latency requirement 124 of the application 125 in accessing the memory 109 and in accessing acceleration services (e.g., provided via the accelerators 127, . . . , 147) over the time sensitive networking bus 104. In some situations, the component 106 can change the latency requirement 124 based on resources (e.g., buffer memory) available in the component 106 for the application 125.

Optionally, the timing data 123 can further include an indication of the duration of a virtual channel to be used by the application 125, an amount of bandwidth to be used by the application 125 in communications through the virtual channel, etc. Such communication attributes can be used to improve or optimize the usages of resources in the allocation or adjustment of virtual channels in the time sensitive networking bus 104.

Similarly, the agent 141 in the component 108 can identify timing data 143 for the application 145 running in the component 108, including the urgency level 142 of communications of the application 145 in accessing the memory 109 and in accessing acceleration services of the accelerators 127, . . . , 147 over the time sensitive networking bus 104, the latency requirement 144 of the communications over the time sensitive networking bus 104, etc.

In some implementations, an agent (e.g., 121) can predict some aspects of its timing data (e.g., 123), such as a need to run or start an application (e.g., 125) at a predicted time instance or time window and thus the timing for the allocation of a virtual channel for the application (e.g., 125), the bandwidth and duration of the application (e.g., 125) using the time sensitive networking bus 104, etc.

For example, an artificial neural network can be trained based on past application activities in a component (e.g., 106) (or in the computing system as a whole) to predict such aspects for a subsequent time duration. Alternatively, the manager 102 can be configured to make the predictions to optimize allocation of virtual channels for applications (e.g., 125, 145) for improved performance for the system as a whole.

The agents (e.g., 121, . . . , 141) can communicate the timing data (e.g., 123, 143) to the manager 102. For example, the timing data 123 can be communicated to the manager 102 in connection with a request to open a virtual channel for the application 125 to the memory 109 and/or to an accelerator (e.g., 127 or 147). For example, the timing data 123 can be communicated to the manager 102 in response to a prediction to run the application 125 for the planning of allocation of a virtual channel for the application 125.

In some implementations, the components 106, . . . , 108 (and optionally the manager 102) can communicate with each other to negotiate the hosting of an application (e.g., 125) in a component (e.g., 106). Thus, there can be multiple options to perform a computing task (e.g., in component 106, or in component 108, or via both components 106 and 108).

The manager 102 can include a logic circuit 135 configured to perform the computations for allocation, reservation, adjustments of a virtual channel in the time sensitive networking bus 104 to meet the requirement of the timing data (e.g., 123 or 143) specified for an application (e.g., 125 or 145), in view of virtual channels that have been in allocated and in use, or reserved for applications having high levels of urgency.

The identification of a virtual channel in the time sensitive networking bus 104 can include the identification of a set of rules to implement a fixed delay (or a maximum allowable delay) in communications for an application (e.g., 125) to access memory/storage services hosted on the memory 109 or to access the acceleration service of an accelerator (e.g., 127 or 147). The rules can include the identification of the use of one or more physical connections in the time sensitive networking bus 104, the timing for the communications handled for the virtual channel by the component(s) or memory device(s) involved in the physical connections, etc., such that when communications are performed according to the rules, the timing requirements (e.g., latency requirement 124) are guaranteed to be satisfied.

When meeting the timing requirement for a virtual channel cannot be guaranteed (e.g., for lack of sufficient resources in the time sensitive networking bus 104), the opening of the virtual channel can be delayed until sufficient resources are freed up (e.g., via the closing or restructuring of one or more virtual channels, the change of a timing requirement for a virtual channel, etc.).

To optimize the performance of the system, the manager 102 can be configured to prioritize the allocation of virtual channels for computing tasks having high levels of urgency. Optionally, the computing system can be configured to pause the usages of virtual channels being allocated to computing tasks having low urgency levels to free up resources for the allocation of virtual channels for computing tasks of high urgency levels.

The computations performed for the allocation and adjustment of virtual channels in the time sensitive networking bus 104, and the predictions of application activities and requirements, can involve multiplication and accumulation operations, such as the operations of artificial neural networks.

The manager 102 can include one or more multiplier-accumulator units 131 to accelerate the multiplication and accumulation operations and thus the computations to be performed by the manager 102. For example, the manager 102 can store a set of weight matrices 133, such as the weight matrices of an artificial neural network, and apply inputs against the weight matrices 133 using the multiplier-accumulator unit 131 in performing computations in making predictions, determining rules of virtual channels, searching for solutions to reorganize virtual channels for allocation of a new virtual channel, etc. Alternatively, the manager 102 can use the acceleration services of the accelerators 127, . . . , 147 to perform the multiplication and accumulation operations.

Optionally, the manager 102 is implemented in a stand-alone component that has the logic circuit 135, multiplier-accumulator units 131, and weight matrices 133. In some implementations, the logic circuit 135 is programmed via instructions to perform the computations of the manager 102.

Optionally, the accelerators 127, . . . , 147 are implemented using different technologies, such as synapse memory cell arrays, microring resonators, memristor crossbar, logical multiply-accumulate units, microprocessors, etc. Some types of accelerators 127, . . . , 147 are advantageous in some scenarios (e.g., different patterns of data involved in multiplication and accumulation operations) and/or in some aspects (e.g., computation latency, network communications requirements, energy consumptions). The manager 102 can assign an acceleration task to any of the accelerators 127, . . . , 147 and can select an accelerator (e.g., 127 or 147) to improve or maximize the overall performance level of the computing system.

An acceleration task can include the application of weight data to input data via multiplication and accumulation operations.

In some implementations, the weight data is pre-configured in the accelerator 127, . . . , 147; and the manager 102 is configured to provide a virtual channel for an application (e.g., 125 or 145) to provide the input data to an accelerator (e.g., 127 or 147) and to obtain the result of multiplication and accumulation performed using the weight data and the input data.

In some implementations, the weight data is stored in the memory 109; and the manager 102 is configured to provide a virtual channel for an accelerator (e.g., 127 or 147) to obtain the weight data and be prepared for the acceleration task.

In some implementations, the manager 102 is configured to provide a virtual channel to the accelerator (e.g., from the application 125 or 145 or from the memory 109) to provide the input data, and another virtual channel to the accelerator (e.g., from the application 125 or 145 or from the memory 109) to provide the weight data concurrently.

In some implementations, an acceleration task is formulated in the memory 109; and the manager 102 is configured to provide a virtual channel to an accelerator (e.g., 147) to allow the accelerator to retrieve data to be operated on for the acceleration task from the memory 109, and to store results back to the memory 109.

In some implementations, the manager 102 is configured to provide a virtual channel to an accelerator for the accelerator (e.g., 127 or 147) to receive data of the acceleration task. The virtual channel can be de-allocated while the accelerator (e.g., 127 or 147) is performing the computation of multiplication and accumulation; and another virtual channel is allocated for the accelerator (e.g., 127 or 147) to provide the result for the acceleration task.

Optionally, each of the accelerators 127, . . . , 147 can have buffer memories to receive data of acceleration tasks and buffer results for the acceleration tasks. For example, the buffer memories for the different types of accelerators 127, . . . , 147 can have same memory access performance. Thus, the different characteristics of the accelerators 127, . . . , 147 can be hidden from the allocation of resources for the virtual channels to the accelerators 127, . . . , 147. The accelerators 127, . . . , 147 can have different delays between receiving data of acceleration tasks and providing results. The accelerators 127, . . . , 147 can consume different amounts of energy for performing a same acceleration task. The manager 102 can dynamically assign acceleration tasks to improve or maximize the overall performance of the computing system (e.g., via optimizing a performance goal that is a function of various aspects, such as speed, energy consumption, etc.).

Alternatively, at least a portion of the computations of the manager 102 can be distributed to agents (e.g., 121, 141) across the components 106, . . . , 108 and the accelerators 127, . . . , 147; and the agents (e.g., 121, 141) can cooperate with each other in implementing the manager 102 as a whole. Thus, the implementation of the manager 102 is not limited to an example of a dedicated, stand-alone component/device configured on the time sensitive networking bus 104.

Optionally, the manager 102 is configured to assign acceleration tasks to heterogeneous accelerators 127, . . . , 147 in a way to reduce the energy expenditure in computations of multiplication and accumulation.

For example, a heterogeneous accelerator sub-system can be configured with a plurality of heterogeneous accelerators 127, . . . , 147. In response to a request to perform a task, the manager 102 can analyze the characteristics of input data of the task and dynamically select an accelerator (e.g., 127 or 147) that consumes less energy for the given task.

For example, the accelerators 127, . . . , 147 can be implemented via different types of technologies, such as microring resonators, synapse memory cells, logic circuits, memristors, etc. As a result, the accelerators 127, . . . , 147 can have different energy consumption characteristics. An accelerator of a particular type can consume less energy, and thus advantageous in reduction of energy consumption, in performing computations for inputs having one set of characteristics but not in performing computations for inputs having another set of characteristics. The manager 102 can assign tasks of multiplication and accumulation to accelerators 127, . . . , 147 of different types based at least in part on an analysis of the characteristics of input data of the tasks.

For example, the manager 102 can be configured to not only dynamically allocate virtual channels to meet timing requirements, but also orchestrate workloads of multiplication and accumulation across the heterogeneous accelerators 127, . . . , 147 configured on the time sensitive networking bus 104. In response to a request from the components (e.g., 106 or 108) to perform a task of multiplication and acceleration, the manager 102 can select, from the heterogeneous accelerators 127, . . . , 147, an accelerator (e.g., 127 or 147) for the task not only to balance workloads but also to reduce energy consumption.

For example, an accelerator implemented via microring resonators can consume less energy in performing a task than other types of accelerators when the input data of the task has large magnitudes (or can be transformed, e.g., via bitwise left shift, to have large magnitudes), or has fewer changes from the current states of the microring resonators (e.g., as maintained for performing a prior task), or both. Thus, when a given task has such characteristics, assigning the task to the accelerator implemented via microring resonators can be advantageous in reduction of energy consumption.

For example, an accelerator implemented via synapse memory cells can consume less energy in performing a task than other types of accelerators when most bits of the input data of the task have the value of zero (or can be transformed, e.g., via bit inversion, to have mostly zeros). Thus, when a given task has such characteristics, assigning the task to the accelerator implemented via synapse memory cells can be advantageous in reduction of energy consumption.

For example, an accelerator implemented via memristors can consume less energy in performing a task than other types of accelerators when the input data of the task has small magnitudes (or can be transformed, e.g., via bitwise right shift, to have small magnitudes). Thus, when a given task has such characteristics, assigning the tasks to the accelerator implemented via memristors can be advantageous in reduction of energy consumption.

For example, an accelerator implemented via logic circuits can consume less energy in performing a task than other types of accelerators (e.g., implemented via microring resonators, synapse memory cells, memristors) when the input data of the task have a wide distribution of magnitudes, and a relative even distributions of bits having the value of one and bits having the value of zero. Thus, when a given task has such characteristics, assigning the task to the accelerator implemented via logic circuits can be advantageous in reduction of energy consumption.

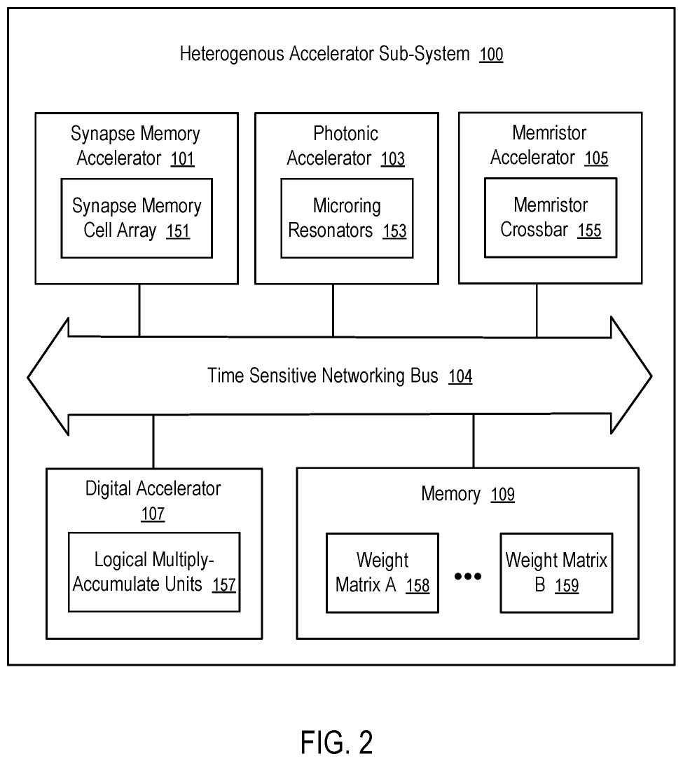

FIG. 2 shows a heterogeneous accelerator sub-system 100 according to one embodiment. For example, the heterogeneous accelerator sub-system 100 of FIG. 2 can be used in the computing system of FIG. 1 to provide the acceleration services of accelerators 127, . . . , 147.

The heterogeneous accelerator sub-system 100 of FIG. 2 includes a time sensitive networking bus 104 connecting a plurality of accelerators (e.g., 101, 103, 105, 107) operable to perform operations of multiplication and accumulation. For example, the accelerators (e.g., 101, 103, 105, 107) can be used to implement the accelerators 127, . . . 147 in FIG. 1.

The memory 109 can be configured to store data used in the operations of multiplication and accumulation, such as weight matrices 158, . . . , 159 used in the applications 125, . . . , 145. Optionally, the applications 125, . . . , 145 can also store input data to be weighted via the weight matrices 158, . . . , 159 in the memory 109 such that the assignment of the acceleration tasks to the accelerators (e.g., 101, 103, 105, 107) can be separate from the components (e.g., 106, 108) running the applications 125, . . . , 145. Alternatively, the accelerators (e.g., 103 or 107) can obtain the weight data from the memory 109. Optionally, the synapse memory cell array 151 and the memristor crossbar 155 can be pre-programmed to store the weight matrices 158, . . . , 159 and store the weight matrices 158, . . . , 159 persistently.

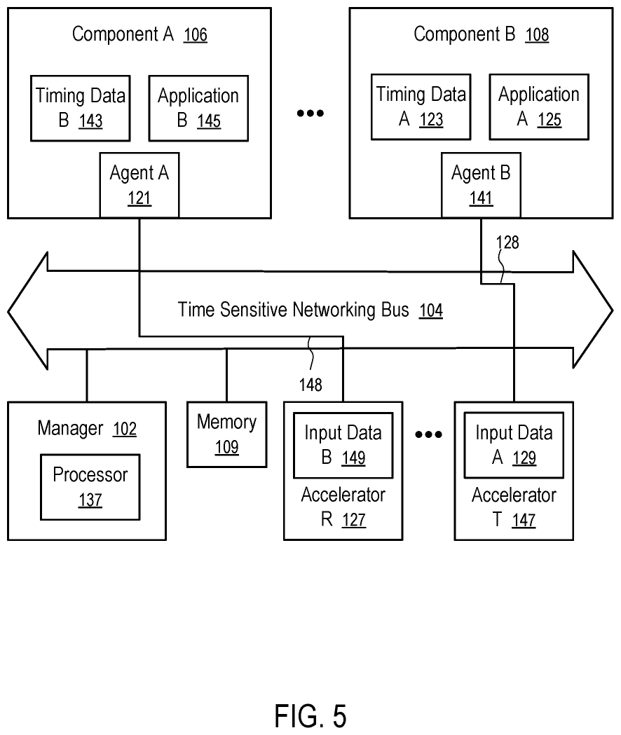

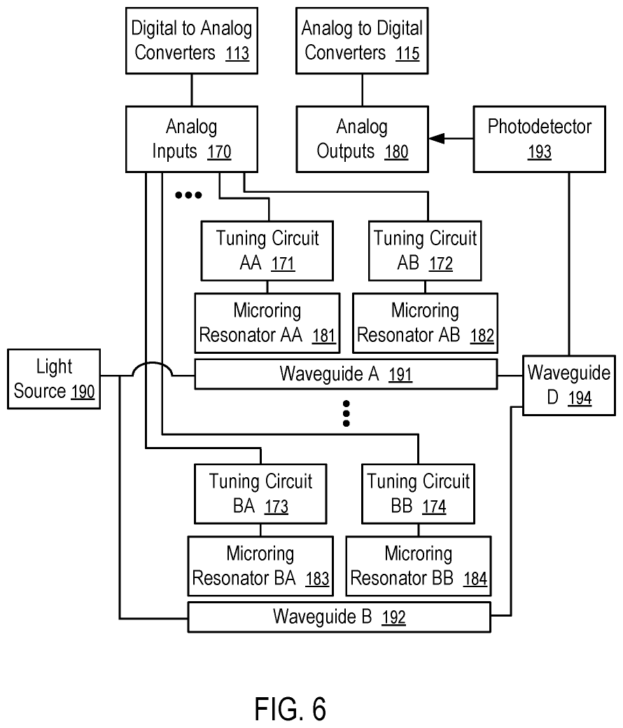

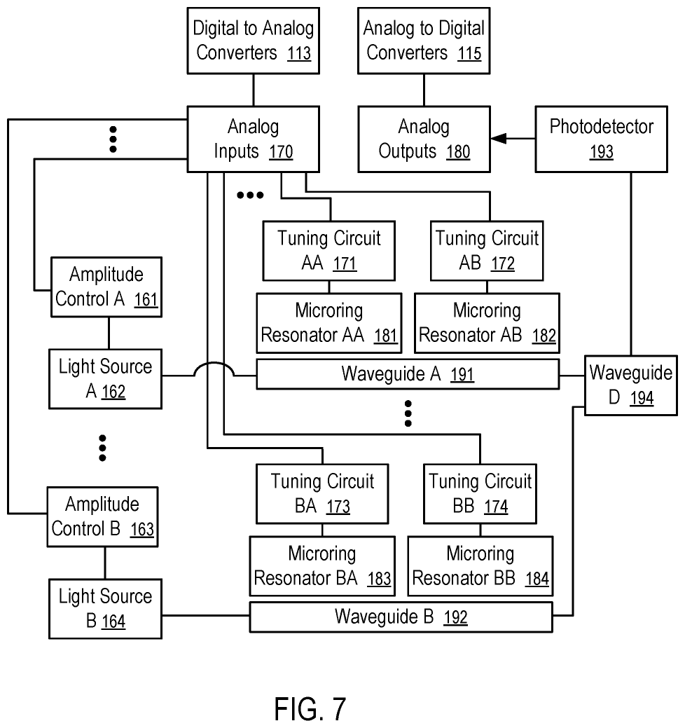

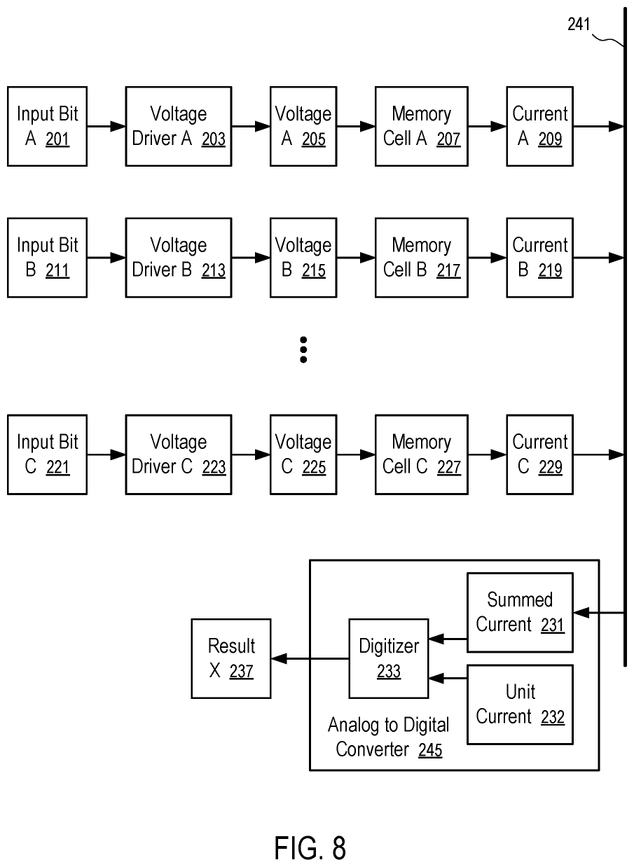

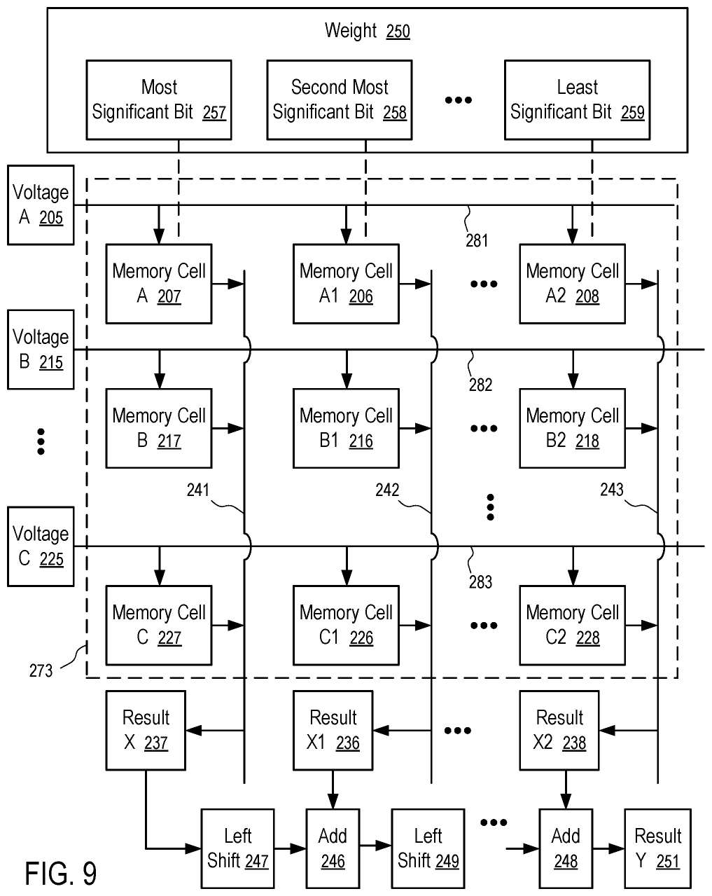

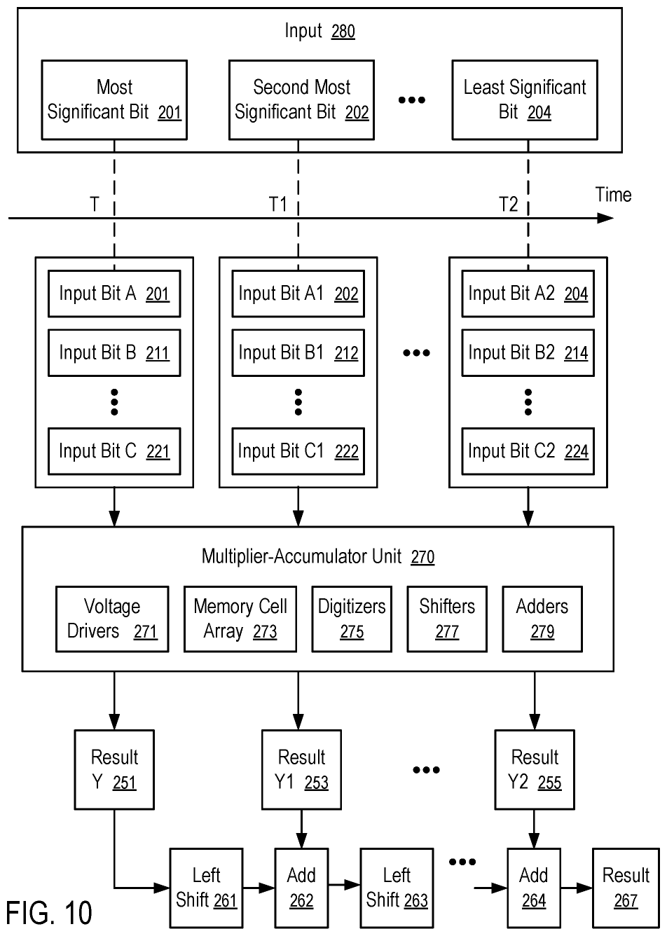

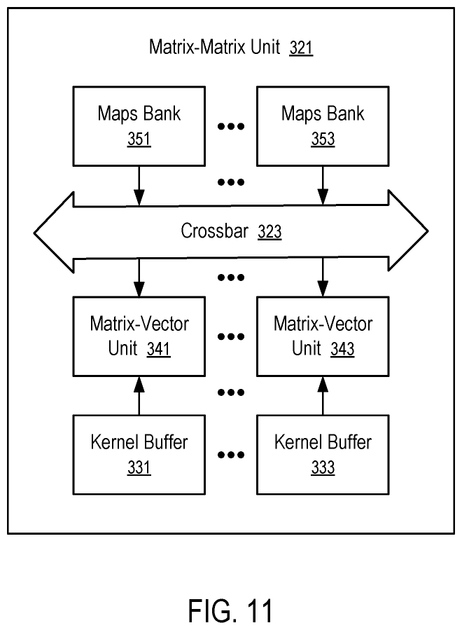

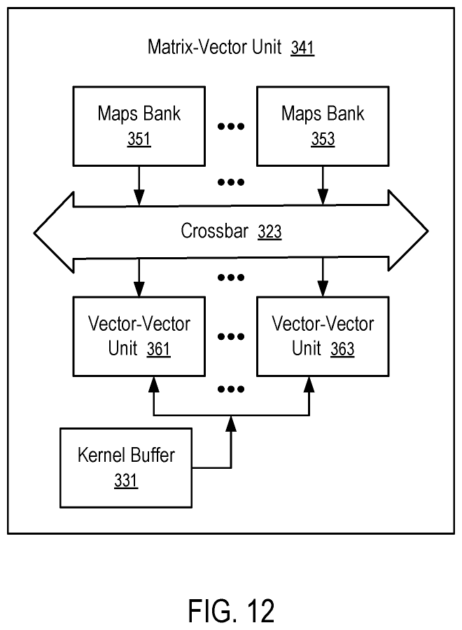

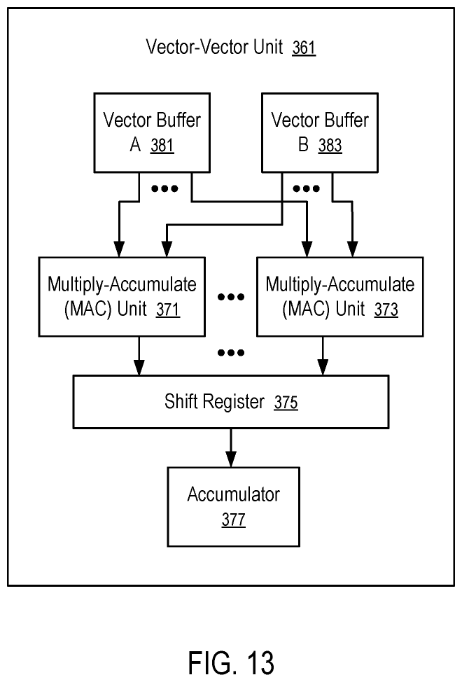

The accelerators (e.g., 101, 103, 105, 107) of the sub-system 100 can be of various different types, such as a synapse memory accelerator 101 having an array 151 of synapse memory cells as computing elements (e.g., as in FIG. 8, FIG. 9, and FIG. 10), a photonic accelerator 103 having microring resonators 153 as computing elements (e.g., as in FIG. 6 and FIG. 7), a memristor accelerator 105 having a crossbar 155 of memristors as computing elements, a digital accelerator 107 having logical multiply-accumulate units 157 as computing elements (e.g., as in FIG. 11, FIG. 12 and FIG. 13), etc.

In general, the heterogeneous accelerator sub-system 100 can have accelerators of any number of types, and any number of accelerators of any particular type. Thus, the combination of accelerators of the sub-system 100 is not limited to the example illustrated in FIG. 2; and more or less accelerators can be configured in the sub-system 100. For example, more than one photonic accelerator (e.g., 103) can be configured in the sub-system 100 in one implementation; the digital accelerator 107 (or the synapse memory accelerator 101) can be omitted in another implementation; and one or more memristor accelerators 105 (or another type of accelerators) can be included in a further implementation.

A manager 102 on the time sensitive networking bus 104 can be configured to manage the workloads of the accelerators (e.g., 101, 103, 105, 107) of the sub-system 100. A request to perform a task of multiplication and accumulation can be directed to the manager 102. The request can include identification of data for the task stored in the memory 109, such as a weight matrix (e.g., 158 or 159), and an input to be weighted according to the weight matrix (e.g., 158 or 159) through an operation of multiplication and accumulation.

Optionally, the manager 102 can analyze the data of an acceleration task to determine the energy efficiency rankings of the available accelerators (e.g., 101, 103, 105, 107) in performing the task. Based on the energy efficiency rankings, workloads of the accelerators, and availability of the accelerators, the manager 102 can select an accelerator (e.g., 101, 103, 105, or 107) to perform the task, and assign the task for performance by the selected accelerator (e.g., 101, 103, 105, or 107).

Alternatively, the energy efficiency rankings can be predetermined for the applications 125, . . . , 145. Thus, the selection of an accelerator (e.g., 101, 103, 105, or 107) can be performed based on the identity of the application (e.g., 125 or 145) requesting the acceleration, the availability of the accelerators (e.g., 101, 103, 105, 107), and the urgency level of the request.

For example, when there are multiple choices of accelerators to perform the task based on load balancing and availability, the manager 102 can select an accelerator that can consume the least amount of energy for the task and assign the task to the selected accelerator.

Optionally, the manager 102 can transform the input data to reduce the energy expenditure of the accelerator selected to perform the task.

For example, when the photonic accelerator 103 is selected for the task, the manager 102 can bitwise shift the data (e.g., weight matrix 158 or 159) to increase the magnitudes of the data, and perform reverse bitwise shift on the computation result produced by the photonic accelerator 103 for the task.

For example, when a memristor accelerator is selected for the task, the manager 102 can bitwise shift the data (e.g., weight matrix 158 or 159) to decrease the magnitudes of the data, and perform reverse bitwise shift on the computation result produced by the memristor accelerator 103 for the task.

For example, when a synapse memory accelerator 101 is selected for the task, the manager 102 can invert the bit values of the data to increase the ratio of bits having the value of zero, and adjust the computing result produce by the synapse memory accelerator 101 to generate the corresponding result for the non-inverted data.

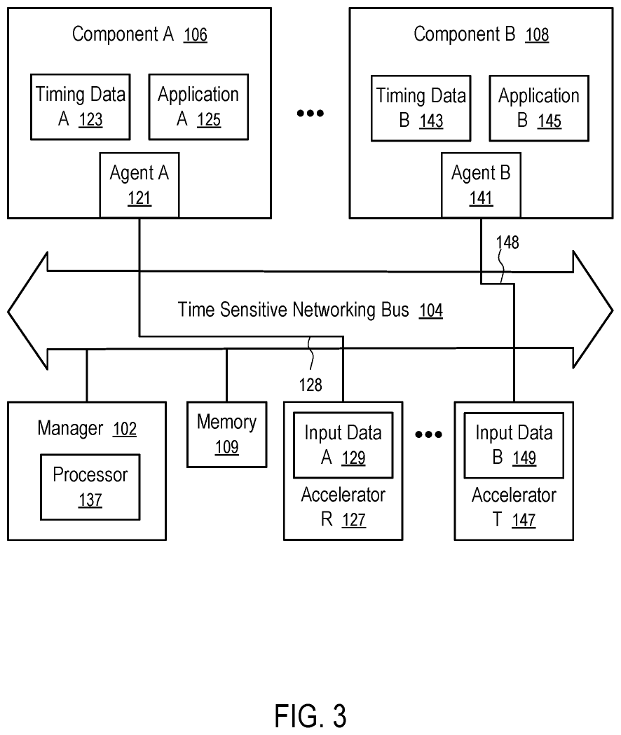

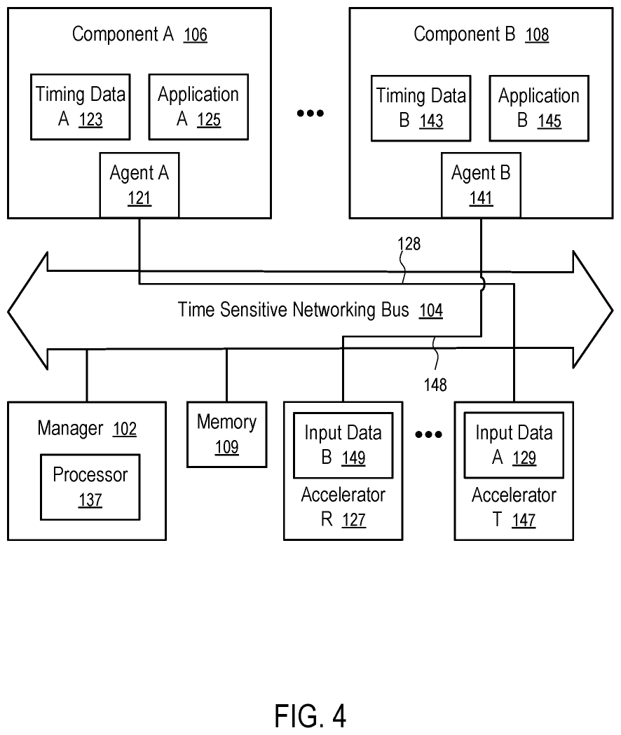

FIG. 3, FIG. 4, and FIG. 5 illustrate examples of dynamic allocations of virtual channels for communication over a time sensitive networking bus to access accelerators of multiplication and accumulation operations according to one embodiment. For example, the dynamic allocations of virtual channels as illustrated in FIG. 3, FIG. 4, and FIG. 5 can be implemented in the computing system of FIG. 1. For example, the acceleration services of the accelerators 127, . . . , 147 can be implemented via an accelerator sub-system of FIG. 2.

In FIG. 3, FIG. 4, and FIG. 5, the manager 102 includes a processor 137 programmed to perform dynamic allocations of virtual channels according to a set of instructions. The instructions can be programmed to use an accelerator (e.g., 127 or 147) or an accelerator sub-system 100 to perform multiplication and accumulation. Optionally, the manager 102 can have one or more multiplier-accumulator units 131 and logic circuits 135 as in FIG. 1.

For example, when the application 125 running the component 106 is in need for an acceleration service from the accelerators 127, . . . , 147, the manager 102 can allocate a virtual channel 128 through the time sensitive networking bus 104 to access an accelerator 127.

For example, the accelerator 127 can be selected for the application 125 based on the workloads of the accelerators 127, . . . , 147, the timing data 123 of the application 125, a pattern of the data of the application to be processed in the acceleration service, etc. The data pattern can be identified based on an analysis of the data, or an identification of the application 125 that is pre-associated with a data pattern/characteristics.

For example, the accelerator 127 can have a buffer memory configured to receive input data 129 from the application. The virtual channel 128 can be allocated for the application 125 to stream input data 129 to the buffer memory of the accelerator 127 for the applying of weights via multiplication and accumulation. The virtual channel 128 includes the identification of a set of physical connections in the time sensitive networking bus 104 and a set of rules for devices involved in the set of physical connections to perform operations such that the delay and latency of communications over the virtual channel 128 is deterministic according to the time data 123 of the application 125.

Similarly, the accelerator 127 can have a buffer memory configured to provide results generated in performing an acceleration task to the application. The virtual channel 128 can be allocated for the application 125 to stream the results from the buffer memory of the accelerator 127 to the application 125. The virtual channel 128 includes the identification of a set of physical connections in the time sensitive networking bus 104 and a set of rules for devices involved in the set of physical connections to perform operations such that the delay and latency of communications over the virtual channel 128 is deterministic according to the time data 123 of the application 125.

In some implementations, the weights used by the application 125 are pre-programmed in the accelerators 127, . . . , 147. Thus, the manager 102 can connect the application 125 to any of the accelerators 127, . . . , 147 to provide the acceleration service requested by the application 125.

In some implementations, a copy of the weights used by the application 125 is accessible in the memory 109. The manager 102 can provide a virtual channel between the memory 109 and an accelerator (e.g., 127) to allow the accelerator 127 to use the weights, or to program the accelerator 127 with the weights.

Similarly, in response to another application 145 running the component 108 is in need for an acceleration service from the accelerators 127, . . . , 147, the manager 102 can allocate a virtual channel 148 through the time sensitive networking bus 104 for the application to access another accelerator 147.

When the time sensitive networking bus 104 has sufficient resources to satisfy the requirements identified in the timing data 123 and 143 for the applications 125 and 145, the manager 102 can allocate the virtual channel 148 without modifying the virtual channel 128. The virtual channel 148 includes the identification of a set of physical connections in the time sensitive networking bus 104 and a set of rules for devices involved in the set of physical connections to perform operations such that the delay and latency of communications over the virtual channel 148 is deterministic according to the time data 143 of the application 145.

In some instances, the virtual channels 128 and 148 can share a portion of the physical paths through the time sensitive networking bus 104, such as a switch, a hub, a cache, a buffer, or a physical connection/wire, etc., when the shared portion is sufficient to meet the demands of the timing data 123 and 143 when operating according to the rules specified for the virtual channels 128 and 148.

However, in some instances, when the time sensitive networking bus 104 has insufficient resources to satisfy the requirements of the timing data 143 without modifying the virtual channel 128 (e.g., due to the latency of accelerator 147 and/or the physical connection available for communicating with the accelerator 147), the manager 102 can adjust the allocation of the virtual channel 128 to accommodate the needs of the application 145 (e.g., when the urgency level 142 of the application 145 is higher than the urgency level 122 of the application 125).

For example, as illustrated in FIG. 4, the manager 102 can cause the move of an acceleration task of the application 125 from the accelerator 127 to the accelerator 147 to free up resources for the allocation of a virtual channel 148 to the accelerator 127 so that the requirements in the timing data 143 of the application 145 are satisfied.

Optionally, the manager 102 can negotiate with the agent 121 in the component 106 to reduce the timing requirements (e.g., latency requirement 124) of the application 124 to facilitate the modification of the virtual channel 128.

Optionally, the manager 102 can request the application 125 to pause the use of the virtual channel 128 as allocated in FIG. 3 for a period of time to accommodate the change.

In general, the modification of the virtual channel 128 (and the pause of its usage) can cause delay and performance degradation for the application 125. However, when the application 145 has an urgency level 142 higher than the urgency level 122 of the application 125, it can be beneficial for the improvement of the overall performance of the computing system.

In general, the time sensitive networking bus 104 can have a plurality of active virtual channels (e.g., 128) when there is a need to allocate a new virtual channel (e.g., 148) for an application (e.g., 145). The manager 102 can search for a solution, among possible options, that improves or optimizes the performance of the computing system as a whole.

In some implementations, the manager 102 or an agent (e.g., 141) can predict the need to run an application (e.g., 145); and the manager 102 can select a virtual channel (e.g., 128) and prepare the modification of the selected virtual channel (e.g., 128) to minimize the disruption to the application (e.g., 125) that uses the selected virtual channel (e.g., 128).

Optionally, the manager 102 or an agent (e.g., 141) can predict certain aspects or requirements of the timing data 143 of the application 145 (e.g., communication bandwidth usages of the application 145, permissible adjustments to requirements for latency, permissible adjustments urgency levels). For example, a predictive model or an artificial neural network can be trained using past activities of the computing system to make the predictions for a subsequent period of time; and the predictions can be used to find an optimized solution for dynamic allocations and modifications of virtual channels (e.g., 128, 148).

In some implementations, the manager 102 can communicate with the agents 121, . . . , 141 to negotiate the host of applications (e.g., 125, 145). Thus, the modification of the virtual channel 128 to accommodate the allocation of a virtual channel 148 can include a change of hosting of one or more applications, as illustrated in FIG. 5.

For example, for improved performance of the system as a whole, the host of the application 145 can be moved from the component 108 (as in FIG. 3) to the component 106 (as in FIG. 5). Similarly, the host of the application 125 can be moved from the component 106 (as in FIG. 3) to the component 108 (as in FIG. 5). The adjustment of the hosting of the applications (e.g., 125 and 145) can free up resources for the adjustment of the virtual channel 128 used by the application 125 and for the allocation of the virtual channel 148 for the application 145. Optionally, the hosting of the data (e.g., 129 and 149) in the accelerators (e.g., 127, 147) for the applications (e.g., 125 and 145) can be changed as well, as illustrated in FIG. 5.

Options for the adjustments of the assignments of acceleration tasks to the accelerators (e.g., 127, 147), and the options for the adjustments of the hosting of the applications (e.g., 125, 145) can increase the flexibility in dynamic allocation/modification of virtual channels (e.g., 128 and 148) in the time sensitive networking bus 104. The options can also increase the complexity of the computations in finding a solution with improved or optimized performance for the computing system as a whole. Inferences computations (e.g., configured based on artificial neural networks and predictive models) can be used to balance the performance in the speed to find a solution and the performance in the quality of the solution that minimizes disruption and improves the overall performance of the computing system.

For example, a non-volatile memory cell array in the synapse memory accelerator 101 can be programmable in a synapse mode to store weight matrices 133 for multiplication and accumulation operations, as further discussed in connection with FIG. 8, FIG. 9, and FIG. 10. The synapse memory accelerator 101 has voltage drivers and current digitizers. During multiplication and accumulation operations, the synapse memory accelerator 101 can use the voltage drivers to apply read voltages, according to input data, onto wordlines connected to memory cells programmed in the synapse mode to generate currents representative of results of multiplications between the weight data and the input data. The currents are summed in an analog form in bitlines connected to the memory cells programmed in the synapse mode. The current digitizers can convert the currents summed in bitlines to digital results.

Optionally, a portion of the non-volatile memory cell array can be programmed in a storage mode to store data, such as the timing data 123, . . . , 143 of the applications 125, . . . , 145. Memory cells programmed in the storage mode can have better performance in data storage and data retrieval than memory cells programmed in the synapse mode, but can lack the support for multiplication and accumulation operations.

Optionally, one or more of the accelerators 127, . . . , 147 can include a synapse memory accelerator 101 to provide memory/storage services using its memory cell array and optionally provide a service of multiplication and accumulation.

For example, data can be written into a predefined region of memory addresses in the synapse memory accelerator 101, the synapse memory accelerator 101 can use as weight data to program a region of its non-volatile memory cell array in the synapse mode. When input data is written into another predefined region of memory addresses in the synapse memory accelerator 101, the synapse memory accelerator 101 can use the input data to read the region of the non-volatile memory cell array, programmed in the synapse mode to store the weight data, to obtain the results of multiplication and accumulation applied to the weight data and the input data. The synapse memory accelerator 101 can store the results in a further predefined region of memory addresses; and the results can be read from the further predefined region of memory addresses. Thus, the synapse memory accelerator 101 can be used in the computing system as an accelerator for multiplication and accumulation by writing data into predefined address regions and reading results from associated address regions.

Optionally, one of the accelerators 127, . . . , 147 configured with a synapse memory accelerator 101 is further configured to perform the computations of the manager 102.

Optionally, the manager 102 can be implemented via distributed computing implemented via the agents 121, . . . , 141 of the components 106, . . . , 108 and optionally the accelerators 127, . . . , 147.

Optionally, the accelerators 127, . . . , 147 can be further configured (e.g., via instructions) to perform the computation of an artificial neural network. For example, a component (e.g., 106 or 108 or the manager 102) can write instructions for the computation of the artificial neural network to a predefined address region configured for instructions for computations of the artificial neural network, the weight data of the artificial neural network to a predefined address region configured for weight data, and input data to the artificial neural network to a predefined address region configured for input. An accelerator (e.g., 127, . . . , 147) can execute the instructions to store the outputs of the artificial neural network to a predefined address region for output. The memory regions can be configured in the memory 109, and/or in the buffer memory of a respective accelerator 127. Thus, the component (e.g., 106 or 108) in the computing system can use the accelerators 127, . . . , 147 as a co-processor for perform the computations of an artificial neural network.

FIG. 6 shows an analog accelerator implemented using microring resonators according to one embodiment. For example, the photonic accelerator 103 of the heterogeneous accelerator sub-system 100 of FIG. 2 can be implemented in a way as in FIG. 6.

In FIG. 6, digital to analog converters 113 can convert digital inputs (e.g., input data 129 or 149) into corresponding analog inputs 170; and analog outputs 180 can be converted to digital forms via analog to digital converters 115.

The analog accelerator of FIG. 6 has microring resonators 181, 182, . . . , 183, and 184, and a light source 190 (e.g., a semiconductor laser diode, such as a vertical-cavity surface-emitting laser (VCSEL)) configured to feed light inputs into waveguides 191, . . . , 192.

Each of the waveguides (e.g., 191 or 192) is configured with multiple microring resonators (e.g., 181, 182; or 183, 184) to change the magnitude of the light going through the respective waveguide (e.g., 191 or 192).

A tuning circuit (e.g., 171, 172, 173, or 174) of a microring resonator (e.g., 181, 182, 183, or 184) can change resonance characteristics of the microring resonator (e.g., 181, 182, 183, or 184) through heat or carrier injection.

Thus, the ratio between the magnitude of the light coming out of the waveguide (e.g., 191) to enter a combining waveguide 194 and the magnitude of the light going into the waveguide (e.g., 191) near the light source 190 is representative of the multiplications of attenuation factors implemented via tuning circuits (e.g., 171 and 172) of microring resonators (e.g., 181 and 182) in electromagnetic interaction with the waveguide (e.g., 191).

The combining waveguide 194 sums the results of the multiplications performed via the lights going through the waveguides 191, . . . , 192. A photodetector 193 is configured to convert the combined optical outputs from the waveguide into analog outputs 180 in the electrical domain.

For example, a set of inputs from the input data (e.g., 129 or 149) can be applied as a portion of analog inputs 170 to the tuning circuits 171, . . . , 173; and a set of weight elements from a row of the weight matrix 158 can be applied via another portion of analog inputs 170 to the tuning circuits 172, . . . , 174; and the output of the combining waveguide 194 to the photodetector 193 represents the multiplication and accumulation between the set of inputs weight via the set of weight elements. Analog to digital converters 115 can convert the analog outputs 180 into an output.

The same set of input elements as applied via the tuning circuits 171, . . . , 173 can be maintained while a set of weight elements from a next row of the weight matrix 158 can be applied via a portion of analog inputs 170 to the tuning circuits 172, . . . , 174 to perform the multiplication and accumulation of weights of the next row to the input elements. After completion of the computations involving the same set of input elements, a next set of input elements can be loaded from the input data (e.g., 129 or 149) in the memory 109.

Alternatively, a same set of weight elements from a row of the weight matrix 158 can be maintained (e.g., via a portion of analog inputs 170 to the tuning circuits 172, . . . , 174) for different sets of input elements. After completion of the computations involving the same set of weight elements, a next set of weight elements can be loaded from the weight matrix 158 in the memory 109.

Alternatively, inputs can be applied via the tuning circuits 172, . . . , 174; and weight elements can be applied via the tuning circuits 171, . . . , 173.

FIG. 7 shows another accelerator implemented using microring resonators according to one embodiment. For example, the photonic accelerator 103 of the heterogeneous accelerator sub-system 100 of FIG. 2 can be implemented in a way as in FIG. 7.

Similar to the analog accelerator of FIG. 6, the analog accelerator of FIG. 7 has microring resonators 181, 182, . . . , 183, and 184 with tuning circuits 171, 172, . . . , 173, and 174, waveguides 191, . . . , and 192, and a combining waveguide 194.

In FIG. 7, the analog accelerator has amplitude controls 161, . . . , and 163 for light sources 162, . . . , 164 connected to the waveguides 191, . . . , and 192 respectively. Thus, the amplitudes of the lights going into the waveguides 191, . . . , and 192 are controllable via a portion of analog inputs 170 connected to the amplitude controls 161, 163. The amplitude of the light coming out of a waveguide (e.g., 191) is representative of the multiplications of the input to the amplitude control (e.g., 161) of the light source (e.g., 162) of the waveguide (e.g., 191) and the inputs to the tuning circuits (e.g., 171 and 172) of microring resonators (e.g., 181 and 182) interacting with the waveguide (e.g., 191).

For example, inputs from the input data (e.g., 129 or 149) can be applied via the amplitude controls 161, . . . , 163; weight elements from the weight matrix 158 can be applied via the tuning circuits 171, . . . , 173 (or 172, . . . , 174); and an optional scaling factor can also be applied via the tuning circuits 172, . . . , 174 (or 171, . . . , 173).

Alternatively, inputs from the input data (e.g., 129 or 149) can be applied via the tuning circuits 171, . . . , 173 (or 172, . . . , 174); and weight elements from the weight matrix 158 can be applied via the amplitude controls 161, . . . , 163.

Optionally, microring resonators 182, . . . , 184 and their tuning circuits 172, . . . , 174 can be omitted. A scaling factor can be applied by the manager 102.

FIG. 8 shows the computation of a column of weight bits multiplied by a column of input bits to provide an accumulation result according to one embodiment. For example, the synapse memory cell array 151 in a synapse memory accelerator 101 of FIG. 2 can be configured in a way as illustrated in FIG. 8 to perform operations of multiplication and accumulation.

In FIG. 8, a column of synapse memory cells 207, 217, . . . , 227 (e.g., in the memory cell array 151 of a synapse memory accelerator 101) can be programmed in the synapse mode to have threshold voltages at levels representative of weights stored one bit per memory cell.

The column of memory cells 207, 217, . . . , 227, programmed in the synapse mode, can be read in a synapse mode, during which voltage drivers 203, 213, . . . , 223 are configured to apply voltages 205, 215, . . . , 225 concurrently to the memory cells 207, 217, . . . , 227 respectively according to their received input bits 201, 211, . . . , 221.

For example, when the input bit 201 has a value of one, the voltage driver 203 applies the predetermined read voltage as the voltage 205, causing the memory cell 207 to output the predetermined amount of current as its output current 209 if the memory cell 207 has a threshold voltage programmed at a lower level, which is lower than the predetermined read voltage, to represent a stored weight of one, or to output a negligible amount of current as its output current 209 if the memory cell 207 has a threshold voltage programmed at a higher level, which is higher than the predetermined read voltage, to represent a stored weight of zero. However, when the input bit 201 has a value of zero, the voltage driver 203 applies a voltage (e.g., zero) lower than the lower level of threshold voltage as the voltage 205 (e.g., does not apply the predetermined read voltage), causing the memory cell 207 to output a negligible amount of current at its output current 209 regardless of the weight stored in the memory cell 207. Thus, the output current 209 as a multiple of the predetermined amount of current is representative of the result of the weight bit, stored in the memory cell 207, multiplied by the input bit 201.

Similarly, the current 219 going through the memory cell 217 as a multiple of the predetermined amount of current is representative of the result of the weight bit, stored in the memory cell 217, multiplied by the input bit 211; and the current 229 going through the memory cell 227 as a multiple of the predetermined amount of current is representative of the result of the weight bit, stored in the memory cell 227, multiplied by the input bit 221.

The output currents 209, 219, . . . , and 229 of the memory cells 207, 217, . . . 227 are connected to a common line 241 (e.g., bitline) for summation. The summed current 231 is compared to the unit current 232, which is equal to the predetermined amount of current, by a digitizer 233 of an analog to digital converter 245 to determine the digital result 237 of the column of weight bits, stored in the memory cells 207, 217, . . . , 227 respectively, multiplied by the column of input bits 201, 211, . . . , 221 respectively with the summation of the results of multiplications.

The sum of negligible amounts of currents from memory cells connected to the line 241 is small when compared to the unit current 232 (e.g., the predetermined amount of current). Thus, the presence of the negligible amounts of currents from memory cells does not alter the result 237 and is negligible in the operation of the analog to digital converter 245.

In FIG. 8, the voltages 205, 215, . . . , 225 applied to the memory cells 207, 217, . . . 227 are representative of digitized input bits 201, 211, . . . , 221; the memory cells 207, 217, . . . , 227 are programmed to store digitized weight bits; and the currents 209, 219, 229 are representative of digitized results. Thus, the memory cells 207, 217, . . . , 227 do not function as memristors that convert analog voltages to analog currents based on their linear resistances over a voltage range; and the operating principle of the memory cells in computing the multiplication is fundamentally different from the operating principle of a memristor crossbar. When a memristor crossbar is used, conventional digital to analog converters are used to generate an input voltage proportional to inputs to be applied to the rows of memristor crossbar. When the technique of FIG. 8 is used, such digital to analog converters can be eliminated; and the operation of the digitizer 233 to generate the result 237 can be greatly simplified. The result 237 is an integer that is no larger than the count of memory cells 207, 217, . . . , 227 connected to the line 241. The digitized form of the output currents 209, 219, . . . , 229 can increase the accuracy and reliability of the computation implemented using the memory cells 207, 217, . . . , 227.

In general, a weight involving a multiplication and accumulation operation can be more than one bit. Multiple columns of memory cells can be used to store the different significant bits of weights, as illustrated in FIG. 9 to perform multiplication and accumulation operations.

The circuit illustrated in FIG. 8 can be considered a multiplier-accumulator unit configured to operate on a column of 1-bit weights and a column of 1-bit inputs. Multiple such circuits can be connected in parallel to implement a multiplier-accumulator unit to operate on a column of multi-bit weights and a column of 1-bit inputs, as illustrated in FIG. 9.

The circuit illustrated in FIG. 8 can also be used to read the data stored in the memory cells 207, 217, . . . , 227. For example, to read the data or weight stored in the memory cell 207, the input bits 211, . . . , 221 can be set to zero to cause the memory cells 217, . . . , 227 to output negligible amount of currents into the line 241 (e.g., as a bitline). The input bit 201 is set to one to cause the voltage driver 203 to apply the predetermined read voltage. Thus, the result 237 from the digitizer 233 provides the data or weight stored in the memory cell 207. Similarly, the data or weight stored in the memory cell 217 can be read via applying one as the input bit 211 and zeros as the remaining input bits in the column; and data or weight stored in the memory cell 227 can be read via applying one as the input bit 221 and zeros as the other input bits in the column.

In general, the circuit illustrated in FIG. 8 can be used to select any of the memory cells 207, 217, . . . , 227 for read or write. A voltage driver (e.g., 203) can apply a programming voltage pulse to adjust the threshold voltage of a respective memory cell (e.g., 207) to erase data, to store data or weigh, etc.

FIG. 9 shows the computation of a column of multi-bit weights multiplied by a column of input bits to provide an accumulation result according to one embodiment.

In FIG. 9, a weight 250 in a binary form has a most significant bit 257, a second most significant bit 258, . . . , a least significant bit 259. The significant bits 257, 258, . . . , 259 can be stored in a rows of memory cells 207, 206, . . . , 208 (e.g., in the memory cell array 151 of a synapse memory accelerator 101) across a number of columns respectively in an array 273. The significant bits 257, 258, . . . , 259 of the weight 250 are to be multiplied by the input bit 201 represented by the voltage 205 applied on a line 281 (e.g., a wordline) by a voltage driver 203 (e.g., as in FIG. 8).

Similarly, memory cells 217, 216, . . . , 218 can be used to store the corresponding significant bits of a next weight to be multiplied by a next input bit 211 represented by the voltage 215 applied on a line 282 (e.g., a wordline) by a voltage driver 213 (e.g., as in FIG. 8); and memory cells 227, 226, . . . , 228 can be used to store corresponding of a weight to be multiplied by the input bit 221 represented by the voltage 225 applied on a line 283 (e.g., a wordline) by a voltage driver 223 (e.g., as in FIG. 8).

The most significant bits (e.g., 257) of the weights (e.g., 250) stored in the respective rows of memory cells in the array 273 are multiplied by the input bits 201, 211, . . . , 221 represented by the voltages 205, 215, . . . , 225 and then summed as the current 231 in a line 241 and digitized using a digitizer 233, as in FIG. 8, to generate a result 237 corresponding to the most significant bits of the weights.

Similarly, the second most significant bits (e.g., 258) of the weights (e.g., 250) stored in the respective rows of memory cells in the array 273 are multiplied by the input bits 201, 211, . . . , 221 represented by the voltages 205, 215, . . . , 225 and then summed as a current in a line 242 and digitized to generate a result 236 corresponding to the second most significant bits.

Similarly, the least most significant bits (e.g., 259) of the weights (e.g., 250) stored in the respective rows of memory cells in the array 273 are multiplied by the input bits 201, 211, . . . , 221 represented by the voltages 205, 215, . . . , 225 and then summed as a current in a line 243 and digitized to generate a result 238 corresponding to the least significant bit.

The most significant bit can be left shifted by one bit to have the same weight as the second significant bit, which can be further left shifted by one bit to have the same weight as the next significant bit. Thus, the result 237 generated from multiplication and summation of the most significant bits (e.g., 257) of the weights (e.g., 250) can be applied an operation of left shift 247 by one bit; and the operation of add 246 can be applied to the result of the operation of left shift 247 and the result 236 generated from multiplication and summation of the second most significant bits (e.g., 258) of the weights (e.g., 250). The operations of left shift (e.g., 247, 249) can be used to apply weights of the bits (e.g., 257, 258, . . . ) for summation using the operations of add (e.g., 246, . . . , 248) to generate a result 251. Thus, the result 251 is equal to the column of weights in the array 273 of memory cells multiplied by the column of input bits 201, 211, . . . , 221 with multiplication results accumulated.

In general, an input involving a multiplication and accumulation operation can be more than 1 bit. Columns of input bits can be applied one column at a time to the weights stored in the array 273 of memory cells to obtain the result of a column of weights multiplied by a column of inputs with results accumulated as illustrated in FIG. 10.

The circuit illustrated in FIG. 9 can be used to read the data stored in the array 273 of memory cells. For example, to read the data or weight 250 stored in the memory cells 207, 206, . . . , 208, the input bits 211, . . . , 221 can be set to zero to cause the memory cells 217, 216, . . . , 218, . . . , 227, 226, . . . , 228 to output negligible amount of currents into the line 241, 242, . . . , 243 (e.g., as bitlines). The input bit 201 is set to one to cause the voltage driver 203 to apply the predetermined read voltage as the voltage 205. Thus, the results 237, 236, . . . , 238 from the digitizers (e.g., 233) connected to the lines 241, 242, . . . , 243 provide the bits 257, 258, . . . , 259 of the data or weight 250 stored in the row of memory cells 207, 206, . . . , 208. Further, the result 251 computed from the operations of shift 247, 249, . . . and operations of add 246, . . . 248 provides the weight 250 in a binary form.

In general, the circuit illustrated in FIG. 9 can be used to select any row of the memory cell array 273 for read. Optionally, different columns of the memory cell array 273 can be driven by different voltage drivers. Thus, the memory cells (e.g., 207, 206, . . . , 208) in a row can be programmed to write data in parallel (e.g., to store the bits 257, 258, . . . , 259) of the weight 250.

FIG. 10 shows the computation of a column of multi-bit weights multiplied by a column of multi-bit inputs to provide an accumulation result according to one embodiment.

In FIG. 10, the significant bits of inputs (e.g., 280) are applied to a multiplier-accumulator unit 270 at a plurality of time instances T, T1, . . . , T2.

For example, a multi-bit input 280 can have a most significant bit 201, a second most significant bit 202, . . . , a least significant bit 204.

At time T, the most significant bits 201, 211, . . . , 221 of the inputs (e.g., 280) are applied to the multiplier-accumulator unit 270 to obtain a result 251 of weights (e.g., 250), stored in the memory cell array 273, multiplied by the column of bits 201, 211, . . . , 221 with summation of the multiplication results.

For example, the multiplier-accumulator unit 270 can be implemented in a way as illustrated in FIG. 9. The multiplier-accumulator unit 270 has voltage drivers 271 connected to apply voltages 205, 215, . . . , 225 representative of the input bits 201, 211, . . . , 221. The multiplier-accumulator unit 270 has a memory cell array 273 storing bits of weights as in FIG. 9. The multiplier-accumulator unit 270 has digitizers 275 to convert currents summed on lines 241, 242, . . . , 243 for columns of memory cells in the array 273 to output results 237, 236, . . . , 238. The multiplier-accumulator unit 270 has shifters 277 and adders 279 connected to combine the column result 237, 236, . . . , 238 to provide a result 251 as in FIG. 9. In some implementations, the logic circuits of the multiplier-accumulator unit 270 (e.g., shifters 277 and adders 279) are implemented as part of the inference logic circuit of the synapse memory accelerator 101.

Similarly, at time T1, the second most significant bits 202, 212, . . . , 222 of the inputs (e.g., 280) are applied to the multiplier-accumulator unit 270 to obtain a result 253 of weights (e.g., 250) stored in the memory cell array 273 and multiplied by the vector of bits 202, 212, . . . , 222 with summation of the multiplication results.

Similarly, at time T2, the least significant bits 204, 214, . . . , 224 of the inputs (e.g., 280) are applied to the multiplier-accumulator unit 270 to obtain a result 255 of weights (e.g., 250), stored in the memory cell array 273, multiplied by the vector of bits 202, 212, . . . , 222 with summation of the multiplication results.

The result 251 generated from multiplication and summation of the most significant bits 201, 211, . . . , 221 of the inputs (e.g., 280) can be applied an operation of left shift 261 by one bit; and the operation of add 262 can be applied to the result of the operation of left shift 261 and the result 253 generated from multiplication and summation of the second most significant bits 202, 212, . . . , 222 of the inputs (e.g., 280). The operations of left shift (e.g., 261, 263) can be used to apply weights of the bits (e.g., 201, 202, . . . ) for summation using the operations of add (e.g., 262, . . . , 264) to generate a result 267. Thus, the result 267 is equal to the weights (e.g., 250) in the array 273 of memory cells multiplied by the column of inputs (e.g., 280) respectively and then summed.

A plurality of multiplier-accumulator unit 270 can be connected in parallel to operate on a matrix of weights multiplied by a column of multi-bit inputs over a series of time instances T, T1, . . . , T2.

The synapse memory accelerator 101 of FIG. 2 can be configured to perform operations of multiplication and accumulation in a way as illustrated in FIG. 8, FIG. 9, and FIG. 10.

FIG. 11 shows a processing unit 321 configured to perform matrix-matrix operations according to one embodiment. For example, the logical multiply-accumulate units 157 of the digital accelerator 107 can be configured as the matrix-matrix unit 321 of FIG. 11.

In FIG. 11, the matrix-matrix unit 321 includes multiple kernel buffers 331 to 333 and multiple maps banks 351 to 353. Each of the maps banks 351 to 353 stores one vector of a matrix operand that has multiple vectors stored in the maps banks 351 to 353 respectively; and each of the kernel buffers 331 to 333 stores one vector of another matrix operand that has multiple vectors stored in the kernel buffers 331 to 333 respectively. The matrix-matrix unit 321 is configured to perform multiplication and accumulation operations on the elements of the two matrix operands, using multiple matrix-vector units 341 to 343 that operate in parallel.

A crossbar 323 connects the maps banks 351 to 353 to the matrix-vector units 341 to 343. The same matrix operand stored in the maps bank 351 to 353 is provided via the crossbar 323 to each of the matrix-vector units 341 to 343; and the matrix-vector units 341 to 343 receives data elements from the maps banks 351 to 353 in parallel. Each of the kernel buffers 331 to 333 is connected to a respective one in the matrix-vector units 341 to 343 and provides a vector operand to the respective matrix-vector unit. The matrix-vector units 341 to 343 operate concurrently to compute the operation of the same matrix operand, stored in the maps banks 351 to 353 multiplied by the corresponding vectors stored in the kernel buffers 331 to 333. For example, the matrix-vector unit 341 performs the multiplication operation on the matrix operand stored in the maps banks 351 to 353 and the vector operand stored in the kernel buffer 331, while the matrix-vector unit 343 is concurrently performing the multiplication operation on the matrix operand stored in the maps banks 351 to 353 and the vector operand stored in the kernel buffer 333.

Each of the matrix-vector units 341 to 343 in FIG. 11 can be implemented in a way as illustrated in FIG. 12.

FIG. 12 shows a processing unit 341 configured to perform matrix-vector operations according to one embodiment. For example, the matrix-vector unit 341 of FIG. 12 can be used as any of the matrix-vector units in the matrix-matrix unit 321 of FIG. 11.

In FIG. 12, each of the maps banks 351 to 353 stores one vector of a matrix operand that has multiple vectors stored in the maps banks 351 to 353 respectively, in a way similar to the maps banks 351 to 353 of FIG. 11. The crossbar 323 in FIG. 12 provides the vectors from the maps banks 351 to the vector-vector units 361 to 363 respectively. A same vector stored in the kernel buffer 331 is provided to the vector-vector units 361 to 363.

The vector-vector units 361 to 363 operate concurrently to compute the operation of the corresponding vector operands, stored in the maps banks 351 to 353 respectively, multiplied by the same vector operand that is stored in the kernel buffer 331. For example, the vector-vector unit 361 performs the multiplication operation on the vector operand stored in the maps bank 351 and the vector operand stored in the kernel buffer 331, while the vector-vector unit 363 is concurrently performing the multiplication operation on the vector operand stored in the maps bank 353 and the vector operand stored in the kernel buffer 331.

When the matrix-vector unit 341 of FIG. 12 is implemented in a matrix-matrix unit 321 of FIG. 11, the matrix-vector unit 341 can use the maps banks 351 to 353, the crossbar 323 and the kernel buffer 331 of the matrix-matrix unit 321.

Each of the vector-vector units 361 to 363 in FIG. 12 can be implemented in a way as illustrated in FIG. 13.

FIG. 13 shows a processing unit 361 configured to perform vector-vector operations according to one embodiment. For example, the vector-vector unit 361 of FIG. 13 can be used as any of the vector-vector units in the matrix-vector unit 341 of FIG. 12.

In FIG. 13, the vector-vector unit 361 has multiple multiply-accumulate (MAC) units 371 to 373. Each of the multiply-accumulate (MAC) units 371 to 373 can receive two numbers as operands, perform multiplication of the two numbers, and add the result of the multiplication to a sum maintained in the multiply-accumulate (MAC) unit.

Each of the vector buffers 381 and 383 stores a list of numbers. A pair of numbers, each from one of the vector buffers 381 and 383, can be provided to each of the multiply-accumulate (MAC) units 371 to 373 as input. The multiply-accumulate (MAC) units 371 to 373 can receive multiple pairs of numbers from the vector buffers 381 and 383 in parallel and perform the multiply-accumulate (MAC) operations in parallel. The outputs from the multiply-accumulate (MAC) units 371 to 373 are stored into the shift register 375; and an accumulator 377 computes the sum of the results in the shift register 375.

When the vector-vector unit 361 of FIG. 13 is implemented in a matrix-vector unit 341 of FIG. 12, the vector-vector unit 361 can use a maps bank (e.g., 351 or 353) as one vector buffer 381, and the kernel buffer 331 of the matrix-vector unit 341 as another vector buffer 383.

The vector buffers 381 and 383 can have the same length to store the same number/count of data elements. The length can be equal to, or the multiple of, the count of multiply-accumulate (MAC) units 371 to 373 in the vector-vector unit 361. When the length of the vector buffers 381 and 383 is the multiple of the count of multiply-accumulate (MAC) units 371 to 373, a number of pairs of inputs, equal to the count of the multiply-accumulate (MAC) units 371 to 373, can be provided from the vector buffers 381 and 383 as inputs to the multiply-accumulate (MAC) units 371 to 373 in each iteration; and the vector buffers 381 and 383 feed their elements into the multiply-accumulate (MAC) units 371 to 373 through multiple iterations.

In one embodiment, the communication bandwidth of the bus 104 between the digital accelerator 107 and the memory 109 is sufficient for the matrix-matrix unit 321 to use portions of the memory 109 as the maps banks 351 to 353 and the kernel buffers 331 to 333.

In another embodiment, the maps banks 351 to 353 and the kernel buffers 331 to 333 are implemented in a portion of the local memory of the digital accelerator 107. The communication bandwidth of the bus 104 between the digital accelerator 107 and the memory 109 sufficient to load, into another portion of the local memory, matrix operands of the next operation cycle of the matrix-matrix unit 321, while the matrix-matrix unit 321 is performing the computation in the current operation cycle using the maps banks 351 to 353 and the kernel buffers 331 to 333 implemented in a different portion of the local memory of the digital accelerator 107.

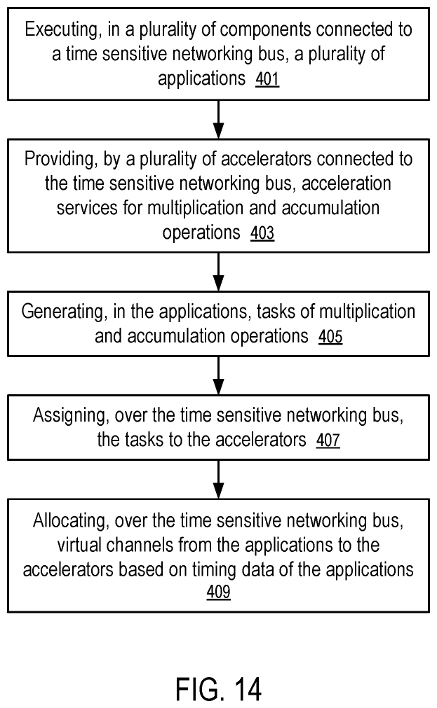

FIG. 14 shows a method of accessing accelerators of multiplication and accumulation operations over a time sensitive networking bus according to one embodiment.

For example, the method of FIG. 14 can be implemented in an apparatus having the computing system of FIG. 1 with accelerators 127, . . . , 147 provided by a heterogeneous accelerator sub-system 100 of FIG. 2. For example, the method of FIG. 14 can be used to implement examples of FIG. 3, FIG. 4, and FIG. 5.

For example, the apparatus can have: a time sensitive networking bus 104, a plurality of accelerators 127, . . . , 147 (e.g., 101, 103, 105, 107) connected to the time sensitive networking bus 104 to accelerate multiplication and accumulation operations; and a plurality of computing components (e.g., 106, . . . , 108) connected to the time sensitive networking bus 104.

For example, the apparatus can further have a memory 109; and the memory 109 can be implemented using a plurality of memory devices having separate physical connections to the time sensitive networking bus 104.

For example, a first accelerator (e.g., 127) of the apparatus can be of a first type; and a second accelerator (e.g., 147) of the apparatus can be of a second type different from the first type. Examples of accelerators of different types can include an accelerator 103 having microring resonators 153 as computing elements, an accelerator 101 having a synapse memory cell array 151 as a computing element, an accelerator 105 having a memristor crossbar 155 as a computing element, an accelerator 107 having a logical multiply-accumulate unit 157 as a computing element, an accelerator 107 having a processor configured in a memory, etc.

Optionally, each of the accelerators (e.g., 127, . . . , 147) can include an input buffer configured to receive input data (e.g., 129 or 149) streamed via a virtual channel (e.g., 128, or 148) over the time sensitive networking bus 104 from a component (e.g., 106 or 108), among the plurality of components (e.g., 106, or 108), to the input buffer.

Optionally, each of the accelerators (e.g., 127, . . . , 147) can include a result buffer configured to provide result data streamed via a virtual channel (e.g., 128, or 148) over the time sensitive networking bus 104 to a component (e.g., 106 or 108), among the plurality of components (e.g., 106 or 108), from the result buffer.

Optionally, at least some of the input buffers and the results buffers can be configured as part of the memory 109 shared by the accelerators 127, . . . , 147.

At block 401, the method includes executing, in a plurality of components 106, . . . , 108 connected to a time sensitive networking bus 104, a plurality of applications 125, . . . , 145.

For example, the time sensitive networking bus 104 includes a network of physical connections configured between various devices, such as components 106, . . . , 108, accelerators (e.g., 127, . . . , 147; 101, 103, 105, 107), manager 102, memory 109, etc. Optionally, the time sensitive networking bus 104 can have switches, hubs, routers, etc. configured to join the physical connections. The transceivers and other communication devices (e.g., switches, hubs, routers, etc.) can be configured according to a set of rules to provide communication paths with deterministic timing characteristics (e.g., in communication delays).

At block 403, the method includes providing, by a plurality of accelerators (e.g., 127, . . . , 147; 101, 103, 105, 107) connected to the time sensitive networking bus 104, acceleration services for multiplication and accumulation operations.

For example, the accelerators (e.g., 127, . . . , 147; 101, 103, 105, 107) can be configured with different types of computing elements, such as microring resonators 153 as computing elements (e.g., as in FIG. 6 and FIG. 7); a synapse memory cell array 151 as a computing element (e.g., as in FIG. 8, FIG. 9, and FIG. 10); a memristor crossbar as a computing element; or a logical multiply-accumulate unit as a computing element (e.g., as a matrix-matrix unit 321 in FIG. 11, a matrix-vector unit 341 in FIG. 12, and a vector-vector unit 361 in FIG. 13).

At block 405, the method includes generating, in the applications 125, . . . , 145, tasks of multiplication and accumulation operations.

For example, a task of multiplication and accumulation operations can include the application of weight data (e.g., weight matrix 158 or 159) to input data (e.g., 129 or 149), as in the computations of an artificial neural network.

The weight data (e.g., weight matrix 158 or 159) can be stored in a memory 109 and used to configure, or accessed by, an accelerator (e.g., 127, 147, 101, 103, 105, 107) for a task of multiplication and accumulation operations.

The input data (e.g., 129 or 149) can be streamed from the applications 125, . . . , 145 to the accelerators (e.g., 127, . . . , 147). Alternatively, the input data (e.g., 129 or 149) can be stream from the applications 125, . . . , 145 into the memory 109 for access by the accelerators.

At block 407, the method includes assigning, over the time sensitive networking bus 104, the tasks to the accelerators (e.g., 127, . . . , 147; 101, 103, 105, 107).

For example, a manager 102 can be configured (e.g., via instructions running on a processor 137 connected on the time sensitive networking bus 104) to receive, from the applications 125, . . . , 145, requests to perform tasks of multiplication and accumulation operations. The requests can include the timing data 123, . . . , 143 of the applications 125, . . . , 145. The manager 102 can select an accelerator (e.g., 127 or 147) to perform a task of multiplication and accumulation operations, based on the workloads of the accelerators (e.g., 127, . . . , 147), the timing data (e.g., 123 or 143) of the application (e.g., 125 or 145) providing the task, the optimization of energy performance of the computing system, etc.

Optionally, the apparatus has a dedicated computing component to implement the manager 102. Alternatively, the manager 102 is implemented (e.g., as an application or service) using one or more of the computing components 106, . . . , 108.

The manager 102 can use an artificial neural network in assigning tasks of the applications 125, . . . , 145 to the accelerators 127, 147 and in allocating communication resources of the bus 104 to the virtual channels (e.g., 128, 148). The manager 102 can outsource the multiplication and accumulation operations of the artificial neural network to the accelerators 127, . . . , 147. Alternatively, the manager 102 is implemented on a computing component having one or more multiplier-accumulator units 131 reserved for the manager 102.

At block 409, the method includes allocating, over the time sensitive networking bus, virtual channels (e.g., 128, 148) from the applications 125, . . . , 145 to the accelerators (e.g., 127, . . . , 147; 101, 103, 105, 107) based on timing data 123, . . . , 143 of the applications 125, . . . , 145.

For example, each of the virtual channels 128, . . . , 148 is configured to have a deterministic timing of communication between a component (e.g., 106 or 108), among the plurality of components (e.g., 106, . . . , 108), and an accelerator (e.g., 127 or 147; 101, 103, 105, or 107).

For example, the timing data 123, . . . , 143 of the applications 125, . . . , 145 can specify the timing requirements for the tasks of the applications 125, . . . , 145 and urgency levels of the tasks. The allocation of the virtual channels 128, . . . 148 can include the identification of rules that, when implemented by the communications devices on the time sensitive networking bus 104, guarantee the timing requirements of the applications 125, . . . , 145.

For example, the manager 102 can optionally adjust the allocation of the communication resources of the time sensitive networking bus 104 for the virtual channels 128, . . . , 148 according to the urgency levels of the tasks.

For example, the virtual channels 128, 148 can be allocated to allow the applications 125, . . . , 145 to stream input data 129, . . . , 149 of the tasks of the applications 145, over the virtual channels 128, . . . , 148 from the applications 125, . . . , 145 to 125, . . . , the respective accelerators 127, . . . , 147 assigned to perform the tasks.

Optionally, the computing system can be configured to store, in a memory 109 connected to the time sensitive networking bus 104, weight data (e.g., weight matrices 158, . . . , 159) of the tasks. The memory 109 can include multiple memory devices having separate physical connections in the time sensitive networking bus 104. The manager 102 can allocate, over the time sensitive networking bus 104, virtual channels from the memory 109 to the accelerators 127, . . . , 147. The virtual channels can be used to configure the accelerators with the weight data (e.g., weight matrices 158, . . . , 159) of the tasks, before the virtual channels 128, . . . , 148 are allocated to stream the input data 129, . . . , 149 to the accelerators 127, 147. Optionally, the accelerators 127, . . . , 147 can access the weight matrices 158, 159 in the memory 109 while the input data 129, . . . , 149 are being streamed from the applications 125, . . . , 145 to the accelerators 127, . . . , 147.

When the result data generated for the tasks is available, the manager 102 can allocate the virtual channels (e.g., 128, 148) for the streaming, to the applications (e.g., 125, 145) over the virtual channels (e.g., 128, 148) from the accelerators (e.g., 127, 147), of the result data generated from the tasks.

In some implementations, the virtual channels (e.g., 128, 148) are used to stream results from the accelerators (e.g., 127, 147) generated from earlier input data, while later input data (e.g., 129, 149) are being streamed concurrently from the applications (e.g., 125, 145) to the respective accelerators (e.g., 127, 147).

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus, comprising:
a time sensitive networking bus;
a plurality of accelerators connected to the time sensitive networking bus to accelerate multiplication and accumulation operations; and
a plurality of components connected to the time sensitive networking bus, the components configured to:
run a plurality of applications;
generate, in the applications, tasks of multiplication and accumulation operations;
assign the tasks to the accelerators; and
allocate virtual channels over the time sensitive networking bus from the applications to the accelerators based on timing data of the applications.

2. The apparatus of claim 1, wherein the time sensitive networking bus includes a network of physical connections configured between the components, and the accelerators; and
wherein each of the virtual channels has a deterministic timing of communication between a component, among the plurality of components, and an accelerator.

3. The apparatus of claim 2, further comprising:
a memory having a plurality of memory devices connected to the time sensitive networking bus;
wherein the plurality of components are further configured to allocate further virtual channels to the memory according to the timing data of the applications to facilitate communications for the tasks.

4. The apparatus of claim 2, wherein the accelerators include:
a first accelerator of a first type; and
a second accelerator of a second type different from the first type.

5. The apparatus of claim 4, wherein the accelerators are configured with:
microring resonators as computing elements;
a synapse memory cell array as a computing element;
a memristor crossbar as a computing element; or
a logical multiply-accumulate unit as a computing element.

6. The apparatus of claim 5, wherein the plurality of components include a first component having a processor configured to run a manager configured to allocate the virtual channels.

7. The apparatus of claim 6, wherein the manager is further configured to receive requests to perform the tasks for the applications and assign the tasks to the accelerators based at least in part on patterns of data to be processed in the tasks.

8. The apparatus of claim 7, wherein the requests include timing requirements for the tasks and urgency levels of the tasks.

9. The apparatus of claim 7, wherein each of the accelerators includes an input buffer configured to receive input data streamed via a virtual channel over the time sensitive networking bus from a component, among the plurality of components, to the input buffer.

10. The apparatus of claim 7, wherein each of the accelerators includes a result buffer configured to provide result data streamed via a virtual channel over the time sensitive networking bus to a component, among the plurality of components, from the result buffer.

11. A method, comprising:
executing, in a plurality of components connected to a time sensitive networking bus, a plurality of applications;
providing, by a plurality of accelerators connected to the time sensitive networking bus, acceleration services for multiplication and accumulation operations;
generating, in the applications, tasks of multiplication and accumulation operations;
assigning, over the time sensitive networking bus, the tasks to the accelerators; and
allocating, over the time sensitive networking bus, virtual channels from the applications to the accelerators based on timing data of the applications.

12. The method of claim 11, wherein the time sensitive networking bus includes a network of physical connections configured between the components, and the accelerators; and
wherein each of the virtual channels has a deterministic timing of communication between a component, among the plurality of components, and an accelerator.

13. The method of claim 12, wherein the accelerators are configured with different types of computing elements, including at least:
microring resonators as computing elements;
a synapse memory cell array as a computing element;
a memristor crossbar as a computing element; or
a logical multiply-accumulate unit as a computing element.

14. The method of claim 13, further comprising:
storing, in a memory connected to the time sensitive networking bus, weight data of the tasks; and
allocating, over the time sensitive networking bus, virtual channels from the memory to the accelerators to configure the accelerators with the weight data of the tasks.

15. The method of claim 13, further comprising:
streaming, from the applications over the virtual channels to the accelerators, input data to be weighted via weight data of the tasks.

16. The method of claim 13, further comprising:
streaming, to the applications over the virtual channels from the accelerators, result data generated from the tasks.

17. A non-transitory computer storage medium storing instructions which, when executed in a computing system, cause the computing system to perform a method, the method comprising:
receiving, over a time sensitive networking bus and from a plurality of applications running in components connected to the time sensitive networking bus, requests to perform tasks of multiplication and accumulation operations;
assigning, over the time sensitive networking bus, the tasks to a plurality of accelerators connected to the time sensitive networking bus; and
allocating, responsive to the requests and over the time sensitive networking bus, virtual channels to the accelerators based on timing data of the applications.

18. The non-transitory computer storage medium of claim 17, wherein a wherein the time sensitive networking bus includes a network of physical connections configured between the components, and the accelerators;
wherein each of the virtual channels has a deterministic timing of communication between a component, among the components, and an accelerator;
wherein the requests include the timing data specifying timing requirements for the tasks and urgency levels of the tasks; and
wherein the accelerators are of different types implemented via at least:
microring resonators as computing elements;
a synapse memory cell array as a computing element;
a memristor crossbar as a computing element; or
a logical multiply-accumulate unit as a computing element.

19. The non-transitory computer storage medium of claim 18, wherein the virtual channels to the accelerators include:
first channels from a memory connected to the time sensitive networking bus to the accelerators to configure the accelerators with weight data of the tasks;
second channels from the components to the accelerators for the components to stream input data of the tasks to the accelerators; and
third channels from the accelerators to the components for the accelerators to stream result data of the tasks to the applications.

20. The non-transitory computer storage medium of claim 18, wherein the virtual channels to the accelerators include:
first channels between a memory connected to the time sensitive networking bus and the accelerators to configure the accelerators with weight data of the tasks;
second channels between the components and the memory for the components to provide input data of the tasks and to retrieve result data of the tasks; and
third channels between the memory and the accelerators for the accelerators to access the input data and to provide the result data of the tasks.
